(19) United States
(12) Patent Application Publication
(10) Pub. No.: US 2018/0033275 A1
(43) Pub. Date: Feb. 1, 2018

(54) An Early Warning Device for Detecting and Reporting Dangerous Conditions in a Community

(71) Applicants: The Sociotech Institute (Pty) Ltd, Cape Town (ZA); University of Cape Town, Cape Town (ZA)

(72) Inventors: Samuel Isaac Ginsberg, Milnerton (ZA); Francois George Petousis, Cape Town (ZA); David Jonathan Gluckman, Cape Town (ZA); Emily Vining, Gardens (ZA); Paul Josef Mesarcik, Cape Town (ZA); Max Basler, Cape Town (ZA)

(21) Appl. No.: 15/546,418

(22) PCT Filed: Jan. 27, 2015
(86) PCT No.: PCT/IB2015/050608

§ 371 Date: Jul. 26, 2017

(51) Int. Cl. G08B 17/10; G08B 25/00; G08B 29/18

(52) U.S. Cl. CPC G08B 17/10; G08B 29/18; G08B 25/002

(57) ABSTRACT

An early warning device, system and method are disclosed. The early warning device includes a sensor which detects an environmental condition and a microprocessor which receives data from the sensor, analyses a change in the environmental condition over time and identifies a dangerous condition if the change in the environmental condition meets a threshold characteristic. A signal transceiver is connected to the microprocessor and sends an alarm signal to other early-warning devices in range if a dangerous condition is identified, and receives alarm signals from other early-warning devices in range. An alarm component connected to the microprocessor is activated by either the identification of a dangerous condition at the device or by receiving one or more alarm signals from other early warning devices in range, so that a plurality of early-warning devices are triggered in the event of a dangerous condition being identified at one or more of them.

### CROSS-REFERENCE TO RELATED APPLICATIONS

This application is a National Stage of International Patent Application No. PCT/IB2015/050608, filed Jan. 27, 2015, the contents of which are incorporated herein by reference in its entirety.

### FIELD OF THE INVENTION

The invention relates to an early warning device for detecting and reporting dangerous conditions in a community.

### BACKGROUND TO THE INVENTION

Uncontrolled fires in urban areas can be devastating, resulting in significant damage to homes and often in loss of life as well. This is particularly so for densely populated urban regions where the fires can spread rapidly. Informal settlements in developing countries, sometimes referred to as shanty towns, typically have closely-spaced homes made out of plywood, corrugated metal, sheets of plastic, and cardboard boxes and are especially prone to uncontrolled fires.

While the prior art has provided various forms of fire alarms in order to combat the spread of uncontrolled fires in urban areas, these devices may be found to be inadequate in the context of informal settlements. Smoke detectors, for example, are commonly used to sense smoke as an indicator of a fire. Household smoke detectors typically issue a local audible or visual alarm from the detector itself in order to alert occupants of imminent danger, while commercial devices as part of a fire alarm system may issue a signal to a fire alarm control panel.

A major limitation of deploying smoke detectors in informal settlements is that, due to the generally smaller living spaces of these homes, inadequate ventilation for smoke, as well as the popularity of open fire or paraffin cooking methods, the rate of false alarms may be unacceptably high. A high false alarm rate naturally harms faith in the system.

Furthermore, while some smoke detectors may be provided as standalone units having their own power source, such devices are limited in that typically only the device having detected smoke sounds an alarm. This limitation is of great significance in informal settlements where fires can spread rapidly.

It is worth noting that more advanced fire alarm systems, typically installed in buildings, can alert an entire building as to the presence of fire in a single room for example, thus overcoming this limitation. However, such fire alarm systems generally require a number of interconnected components and a central control system. This makes the installation of such fire alarm systems expensive and relatively inflexible, with adaptations to the system potentially being cumbersome. There may also be problems associated with ownership and control of these central control systems as a central authority may be required to control and maintain the systems, which is often not feasible.

There is accordingly a need for an early warning device for detecting and reporting fires in communities which addresses these and/or other limitations.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided an early warning device for detecting and reporting dangerous conditions in a community, comprising:

a sensor which detects an environmental condition at the device;

a microprocessor which receives data relating to the environmental condition from the sensor, analyses a change in the environmental condition over time, and identifies a dangerous condition if the change in the environmental condition meets a threshold characteristic;

a signal transceiver connected to the microprocessor which sends an alarm signal to other early-warning devices in range if a dangerous condition is identified, and which receives alarm signals from other early-warning devices in range; and

an alarm component connected to the microprocessor;

wherein the alarm component is activated by either the identification of a dangerous condition at the device, or by receiving one or more alarm signals from other early warning devices in range, so that a plurality of early-warning devices are triggered in the event of a dangerous condition being identified at one or more of them.

Further features provide for the dangerous condition to be a fire, the sensor to be a temperature sensor, and the environmental condition to be temperature.

Still further features provide for the signal transceiver to be a short range radio frequency transceiver that transmits a signal over a range of 1-100 meters in an unlicensed frequency band.

Yet further features provide for the temperature sensor to be a light emitting diode (LED) and the data received from the LED to be a forward-biased voltage over the LED. In one embodiment, the microprocessor periodically supplies a current to the LED in order to raise the forward biased voltage over the LED causing the LED to flash and thereby to indicate a normal operating status to a user.

Further features provide for the device to include a housing and the LED to protrude from the housing, wherein apertures are provided in the housing adjacent to and substantially surrounding the LED to ensure that the LED is exposed to the ambient environment to ensure that a change in ambient temperature can be detected.

Still further features provide for temperature measured by the sensor to be sampled on a periodic basis, and the threshold characteristic indicating a dangerous condition to be that the measured temperature has increased by at least a certain amount for a certain number of successive samples.

Yet further features provide for the microprocessor to further be configured to detect a fault condition in the sensor and to then immediately activate the alarm component and the signal transceiver to send an alarm signal, to thereby prevent a delay which could otherwise result in the device being destroyed before it is capable of transmitting the alarm signal. The fault condition may be the monitored forward biased voltage exceeding a threshold value.

Further features provide for the alarm component to be a buzzer or siren, and the device to include a delay timer which initiates a time delay between the activating of the alarm component and sending an alarm signal to other early-warning devices in range, and the device includes a switch which is operable to reset the device, so that the device can be reset during the time delay so as to silence the buzzer or siren and prevent an alarm signal from being transmitted.

Still further features provide for the device to be operable to retransmit an alarm signal it has received from another early warning device, and for the alarm signal transmitted by the device to include a count value which is received and incremented before being transmitted, so that each retransmitted alarm signal is associated with a count value which indicates the number of times it has been retransmitted.

Yet further features provide for the alarm component to only be activated if the count value is below a first value, and for the alarm signal to only be retransmitted if the count value is below a second value.

Further features provide for the signal transceiver to be operable to receive control messages from a network control device, the control messages being one of: an alarm instruction or a mute instruction, wherein, if the control message is an alarm instruction, the alarm component is activated and the alarm signal is sent to other early-warning devices in range, or, if the message is a mute instruction, the alarm component is silenced and the alarm signal is not transmitted.

Still further features provide for the network control device to be operable to transmit status updates including its geo-location position to a central hub and receive instructions from the central hub, the central hub being capable of activating early-warning devices in range of the network control device upon detection at the central hub of a dangerous condition in the vicinity of the network control device.

Yet further features provide for the LED to be a red green blue (RGB) LED and, if the alarm instruction received from the network controller device is a fire alert, outputting a first colour on the RGB LED, or if the alarm instruction received in a message from the network controller device is a flood alert, outputting a second colour on the RGB LED.

The invention extends to an early warning system for detecting and reporting dangerous conditions in a community, the system comprising a plurality of early warning devices as previously set forth.

Further features provide for the system to include a network control device and a central hub,

the network control device including:

a signal transceiver operable to receive alarm signals from early-warning devices within range; and,

a communication module which is operable to transmit, responsive to the signal transceiver receiving an alarm signal from an early-warning device, an indication of a dangerous condition to a central hub;

and the central hub including:

a communication module operable to receive indications of a dangerous condition from the network control device.

Further features provide for the communication module of the central hub to further be operable to transmit instructions to the network control device, the instructions including a mute instruction or an alarm instruction, wherein the communication module of the network control device is further operable to receive instructions from the central hub and wherein, responsive to receiving an instruction, the signal transceiver of the network control device is further operable to transmit control messages to early-warning devices within range, the control messages being one of an alarm instruction or a mute instruction.

Still further features provide for the signal transceiver of each one of the plurality of early-warning devices to be operable to receive a control message and, if the received control message is an alarm instruction, the alarm component of the device is activated and the alarm signal is sent to other early-warning devices in range, or, if the message is a mute instruction, the alarm component of the device is silenced and the alarm signal is not transmitted.

Yet further features provide for the network control device to include a geo-location module for determining a geo-location position of the network control device, and the communication module of the network control device to periodically transmit status updates including the geo-location position to the central hub.

The invention further extends to a method for detecting and reporting dangerous conditions in a community, the method being conducted at an early-warning device and comprising:

receiving data relating to an environmental condition from a sensor;

analysing a change in the environmental condition over time;

if the change in the environmental condition meets a threshold characteristic, identifying a dangerous condition;

if a dangerous condition is identified or responsive to receiving one or more alarm signals from other early warning devices in range, activating an alarm component; and,

responsive to activating an alarm component, sending an alarm signal to other early-warning devices in range.

Further features provide for the sensor to be an LED and receiving data to include receiving a forward-biased voltage read over the LED.

Still further features provide for the method to include periodically supplying a current to the LED in order to raise the forward biased voltage over the LED causing the LED to flash and thereby to indicate a normal operating status to a user.

Yet further features provide for analysing a change in the environmental condition over time to include analysing temperature samples, and the threshold characteristic indicating a dangerous condition is that the temperature has increased by at least a certain amount for a certain number of successive samples.

Further features provide for the method to include detecting a fault condition in the sensor and then immediately activating an alarm component and sending an alarm signal to other early warning devices in range, thereby preventing a delay which could otherwise result in the device being destroyed before it is capable of transmitting the alarm signal.

Still further features provide for the method to include, if a dangerous condition is identified, initiating a time delay between the step of activating the alarm component and the step of sending an alarm signal to other early-warning devices in range.

An alarm signal received from another early warning device may be retransmitted by the early warning device.

Further features provide for the alarm signal sent by the device to include a count value, the method including incrementing the count value before retransmitting an alarm signal, so that each retransmitted alarm signal is associated with a count value which indicates the number of times it has been retransmitted.

In one embodiment, the alarm component is only activated if the count value is below a first value, and the alarm signal is only retransmitted if the count value is below a second value.

Further features provide for the method to include receiving control messages from a network control device, the control messages being one of: an alarm instruction or a mute instruction, wherein, if the control message is an alarm instruction, the method includes activating an alarm component and sending the alarm signal to other early-warning devices in range, or, if the message is a mute instruction, the method includes silencing the alarm component.

### BRIEF DESCRIPTION OF THE DRAWINGS

The invention will now be described, by way of example only, with reference to the accompanying representations in which:

FIG. 1 is a block diagram which illustrates components of an early warning device according to one embodiment;

FIG. 2 is a three dimensional view of an early warning device housing according to the embodiment;

FIG. 3 is a schematic diagram which illustrates an exemplary early warning system which includes a plurality of early warning devices;

FIG. 4 is a block diagram which illustrates an exemplary network control device and an exemplary central hub of the early warning system;

FIG. 5 is a flow diagram which illustrates a method for detecting and reporting a dangerous condition;

FIG. 6 is a flow diagram which illustrates additional steps of the method of FIG. 5;

FIG. 7 is a flow diagram which illustrates additional steps of the method of FIG. 5;

FIG. 8 is a circuit diagram of the early warning device according to the embodiment;

FIG. 9 is a circuit diagram showing a first part of an exemplary network control device;

FIG. 10 is a circuit diagram showing a second part of the network control device; and,

FIG. 11 is a graph showing rate of rise of temperature versus time in an exemplary shack fire.

### DETAILED DESCRIPTION WITH REFERENCE TO THE DRAWINGS

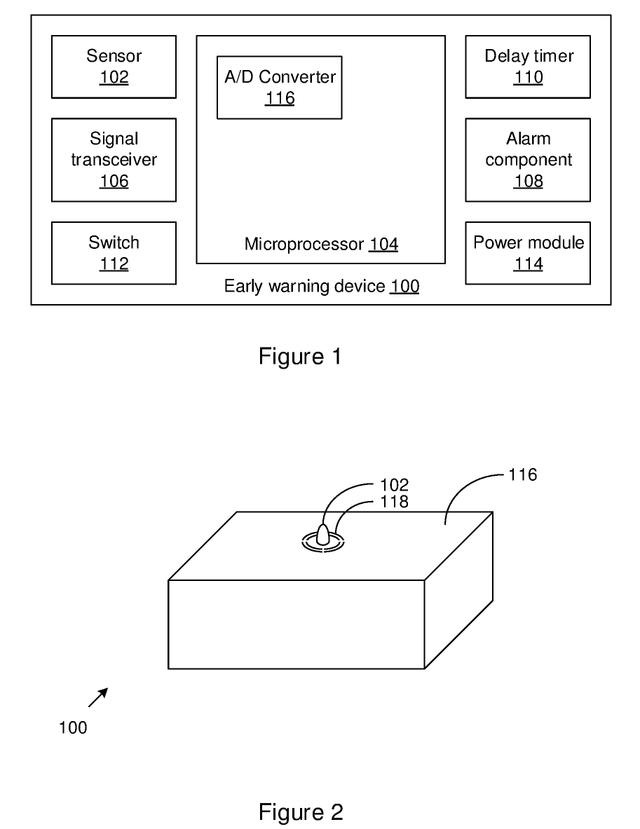

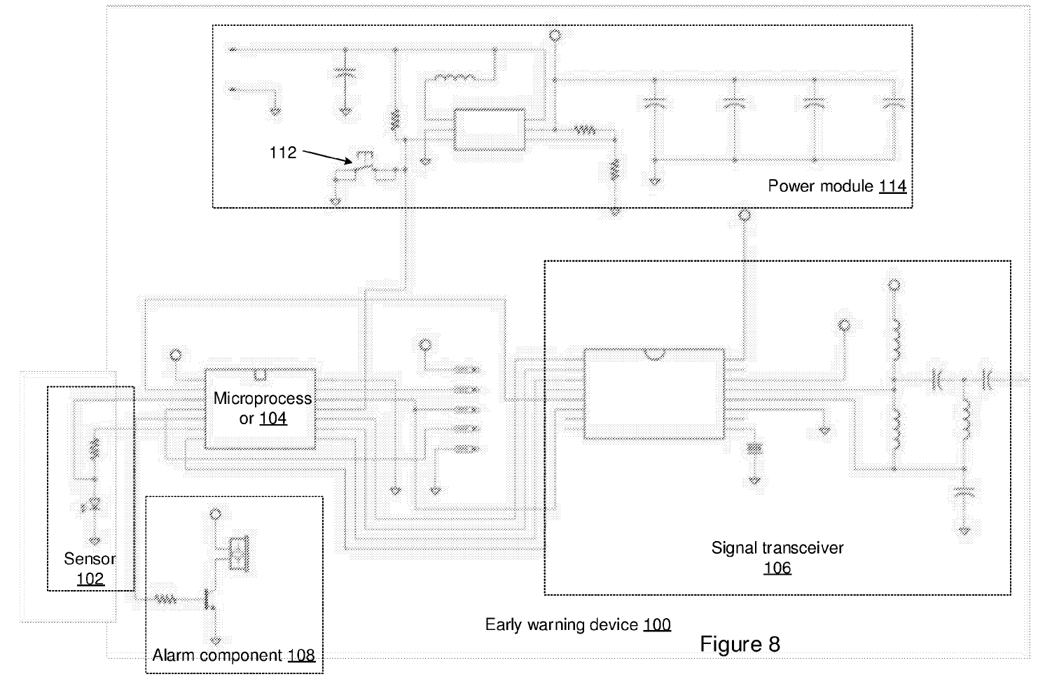

FIGS. 1, 2 and 8 illustrate an exemplary early warning device (100) according to one embodiment. FIG. 1 is a block diagram which illustrates components of the early warning device (100), including a sensor (102), a microprocessor (104), a signal transceiver (106) and an alarm component (108), and FIG. 2 is a three dimensional view of the early warning device (100) itself and FIG. 8 is a circuit diagram of the device.

The sensor (102) detects an environmental condition at the device. In this embodiment, the sensor (102) is a temperature sensor and in the form of a light emitting diode (LED) and the environmental condition is temperature. The voltage drop across a forward-biased semiconductor junction, such as that of an LED, has a negative temperature coefficient. This can be used to detect change in temperature by passing current through the LED and measuring the voltage across it. By measuring temperature, the device is capable of detecting and reporting fires as will be explained herein. Using an LED as the temperature sensor (102) has an advantage in that the same LED can serve two functions, the first being to sense temperature and the second being to indicate the status of the device (100).

The microprocessor (104) may be any suitable microprocessor which meets relevant performance and power requirements. “Microprocessor” as used herein should be given a broad interpretation and is intended to include suitable alternatives such as an application specific integrated circuit (ASIC), a microcontroller, a field programmable gate array (FPGA) and the like.

The microprocessor is configured to default to a sleep mode and to wake periodically responsive to receiving a wake instruction from the signal transceiver (106). The microprocessor (104) periodically supplies a current to the LED causing the LED to flash and thereby to indicate a normal operating status to a user. In this embodiment, the current is supplied every second although higher and lower sample rates may, of course, be used. The microprocessor (104) receives data from the sensor (102) in the form of a forward-biased voltage over the LED, for example using an analogue-to-digital converter (116) of the microprocessor (104) to monitor the voltage. As the current is supplied periodically, the forward-biased voltage gives a temperature indication which is sampled on a periodic basis, in this case once every second.

The microprocessor (104) analyses a change in the environmental condition over time and identifies a dangerous condition, such as a fire, if the change in the environmental condition meets a threshold characteristic. In this embodiment, the threshold characteristic indicating a dangerous condition is that the measured temperature has increased by at least a certain amount for a certain number of successive samples. In this embodiment, fifteen samples are stored in a first-in, first-out (FIFO) register, with each successive sample being compared to the next sample for the purpose of identifying the rate of change. Only if the rate of change from one sample to the next is above a certain threshold, will the threshold characteristic be met. With a 1 Hz sampling rate, it will thus take 15 seconds to detect a fire.

By using rate of change, or the derivative of temperature with respect to time, the device (100) may be used reliably in a wide variety of climates. For example, whether the ambient temperature is 0 degrees Celsius or 40 degrees Celsius, the rate of change of the ambient temperature in the presence of a fire will still exceed the threshold characteristic and thus, the device (100) will still will be operable to detect the fire. In tests, which are discussed in greater detail below, a time derivative of 25 degrees Celsius per minute was found to be an appropriate threshold characteristic for reliably detecting a fire while having an acceptably low false positive rate.

The microprocessor (104) is further configured to detect a fault condition in the sensor (102). The fault condition may be the monitored forward biased voltage exceeding a threshold value, for example indicating that the LED has been destroyed by a fire. In experiments it was found that rapid fires may destroy the device circuitry before the 15 second detection period has passed. Thus, it is advantageous to expose the LED so that it will be destroyed first and responsive to the device detecting that the LED has been destroyed, an alarm signal can be transmitted.

The signal transceiver (106) is a short range radio frequency transceiver and may include an antenna and a dedicated radio transceiver to enable it to send and receive data and messages to and from other surrounding early warning devices within range. The signal transceiver (106) may utilise an unlicensed frequency band and may be capable of transmitting messages and data over a range of, for example, 1-100 m.

The signal transceiver (106) is connected to the microprocessor (104) and is operable to send an alarm signal to other early-warning devices in range if a dangerous condition is identified and to receive alarm signals from other early-warning devices in range. The signal transceiver (106) is also operable to retransmit an alarm signal it has received from a different early warning device.

In this exemplary embodiment, the messages sent from and received by the device (100) are 32-bit binary messages. The binary messages may be encoded onto a 433 MHz radio frequency signal using frequency shift keying (FSK). In other implementations, other frequency bands may be used, which may be licensed or unlicensed, and other methods of encoding the data may be used such as on-off keying.

The first 16 bits identify the message as having originated from a device within an early warning system as described herein. This is to avoid interference from other electronic devices utilising the same frequency band and encoding. The next 8 bits identify the dangerous condition. For example, whether the dangerous condition is a fire or a flood. The remaining 8 bits include one or more of the group of: the count value, alarm signal and instructions such as a mute instruction, a deactivate mute instruction or an alarm instruction of control messages, as will be further described below.

The signal transceiver (106) is also operable to periodically transmit a wake instruction to the microprocessor to cause the microprocessor to wake from a sleep mode and to sample the temperature.

Alarm signals transmitted and received by the signal transceiver (106) include a count value. Count values received in alarm signals are incremented before being transmitted to other early warning devices so that each retransmitted alarm signal is associated with a count value which indicates the number of times it has been retransmitted. Alarm signals are only retransmitted if the count value is below a second value, which is discussed below.

The alarm component (108) is connected to the microprocessor (104) and may be a buzzer or siren. The alarm component (108) is activated by either the identification of a dangerous condition at the device (100) or by receiving one or more alarm signals from other early warning devices in range. In the case of receiving alarm signals from other early warning devices, the alarm component (108) is only activated if the count value is below a first value.

Furthermore, where the signal transceiver (106) receives a control message in the form of an alarm instruction from a network control device, the alarm component (108) is activated and the alarm signal is sent to other early-warning devices in range. On the other hand, if a control message in the form of a mute instruction is received from a network control device, the alarm component (108) is silenced and the alarm signal is not transmitted. The silence instruction may be used for debugging purposes where an early warning device in a community is faulty, causing alarms of surrounding devices to be triggered.

The device (100) further includes a delay timer (110), which is implemented as software running on the microprocessor (104), and which initiates a time delay between the triggering of the alarm component (108) and the sending an alarm signal to other early-warning devices within range. However, when the microprocessor (104) detects a fault condition in the sensor (102), the alarm component (108) is activated without delay and the signal transceiver (106) sends an alarm signal without delay. This prevents a delay which could otherwise result in the device (100) being destroyed before it is capable of transmitting the alarm signal.

The device (100) also includes a switch (112) which is operable to reset the device (100), so that the device can be reset during the time delay so as to silence the buzzer or siren and prevent an alarm signal from being transmitted. This allows an alarm signal to be prevented from propagating from a faulty device or resulting from a fire that has quickly been brought under control, thereby averting a community-wide false alarm. In one embodiment, the switch temporarily disconnects power from the device.

Furthermore, the early warning device (100) includes a power module (114). In the illustrated embodiment, the power module (114) receives one single cell cylindrical dry battery and includes a voltage regulator and a smoothing circuit.

In some embodiments, the LED (102) may be a red green blue (RGB) LED such that the LED (102) can output different colours for different dangerous conditions. For example, if a fire alert alarm signal is received, a first colour may be output on the RGB LED, or if a flood alert alarm signal is received, a second colour may be output on the RGB LED. Other dangerous conditions, such as riots or impending natural disasters may be indicated with other colours. In other embodiments, instead of a single LED having different colours, separate LED's for different dangerous conditions could be provided on the device, where the separate LED's may be differently coloured or differently positioned on the device. Alternatively, different tones or patterns in the audible alarm signal may be sounded by the device, to represent the different dangerous conditions.

Further embodiments provide for the threshold characteristic to be a predetermined threshold which is exceeded and for the sensor to be a water level sensor. By providing an early warning device having a water level sensor and which is configured for absolute level sensing, flash floods can be detected. Such an early warning device may be placed upstream and, responsive to detecting a water level exceeding a predetermined threshold (or by detecting the presence of water), the early warning device may transmit an alarm signal to surrounding early warning devices.

Referring to FIG. 2, the device (100) includes a housing (116) from which the LED (102) protrudes. The housing (116) includes a semi-annular protrusion (122) for mounting the device (100) onto an interior wall of a dwelling and apertures (118) provided therein adjacent to and substantially surrounding the LED (102). The apertures (118) ensure that the LED (102) is fully exposed to the ambient environment so that a change in ambient temperature can be detected and so that, in the presence of very rapid fires, the LED is the first component to be destroyed leading to the fault condition being detected and immediate activation of the alarm component.

The fact that the LED (102) is more exposed to the potential fire than the rest of the device's (100) electronics means that the LED (102) is more likely to be destroyed while the rest of the device is still capable of sending an alert to neighbouring devices. Thus, where a fault condition is detected, indicative of the LED (102) being destroyed in a fire, it is advantageous to transmit an alarm signal immediately before the rest of the device is destroyed (100).

The early warning device (100) as described above thus triggers a plurality of other surrounding early-warning devices in the event of a dangerous condition being identified thereat. As simple wireless communications in the form of broadcast messages are utilised, the device allows for a scalable mesh-networked early warning system.

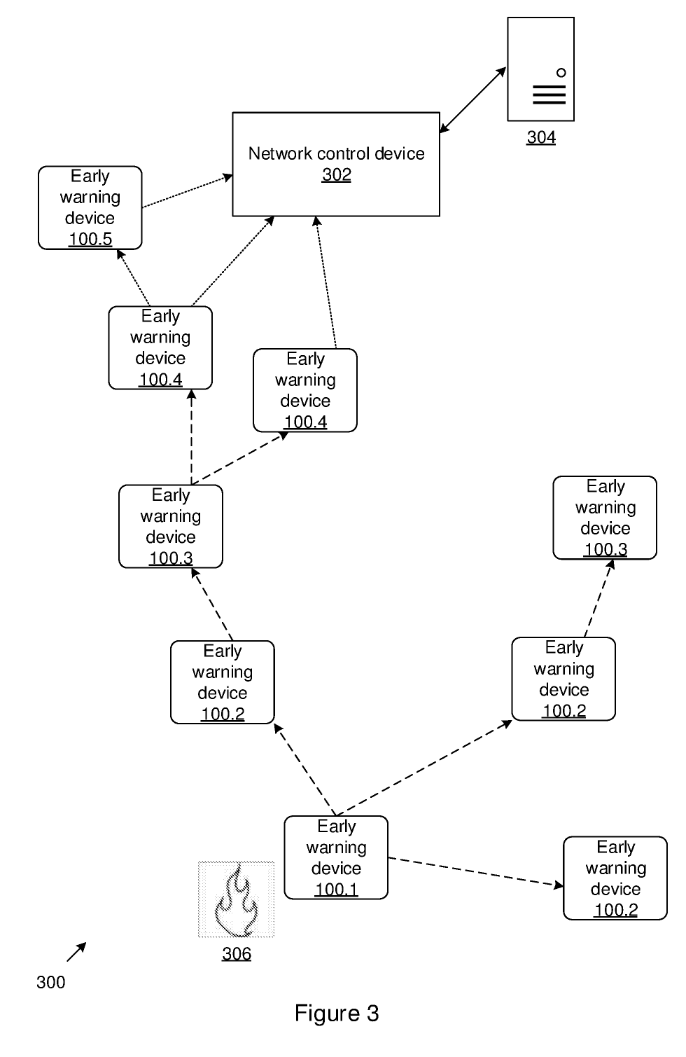

FIG. 3 is a schematic diagram which illustrates an exemplary early warning system (300) which includes a plurality of early warning devices (100). The system (300) also includes a network control device (302) and a central hub (304). Although the system (300) can function without a network control device or central hub, in which case the system functions to form a mesh-networked community-wide early warning system, having network control devices (302) that can communicate with the early warning devices (100) and with a central hub (304) enables forms of centralized monitoring and pro-active warning to be applied, which could be particularly useful for purposes such as automatic dispatch of emergency services.

Each early warning device (100) may be placed inside a house or dwelling within a community, typically being an informal settlement. The early warning device should be placed as high as possible, but within reach, on a wall inside the dwelling. The device (100) should be placed a sufficient distance (e.g. at least 1 metre) away from the cooking area so as to prevent false alarms under normal cooking conditions.

The network control device (302) may be placed at a community centre, on a telephone pole or other form of infrastructure. Although only one network control device is illustrated, it should be appreciated that a number of network control devices may be spread around a community such that each early warning device is within range of a network control device.

The network control device (302) is in communication with the central hub (304) via a communication network, such as a mobile phone network and/or the Internet. The network control device (302) is operable to send and receive messages and data to and from early warning devices within range. The network control device (302) periodically sends status updates to the central hub (304). The status updates may include a geo-location of the network control device (302) as well as communication and power status information, such as signal strength and battery charge.

In particular, the network control device (302) is operable to receive an alarm signal from other early-warning devices in range if a dangerous condition is identified. In response to receiving an alarm signal from an early warning device, the network monitoring device (302) transmits an indication of a dangerous condition to the central hub (304).

The network control device is also operable to transmit control messages to the early warning devices (100). The control message may be either an alarm instruction or a mute instruction. Alarm instructions may be transmitted by the network control device (302) responsive to receiving an instruction from the central hub (304) upon detection at the central hub (304) of a dangerous condition in the vicinity of the network control device (302). In one example, the central hub (304) detects a dangerous condition in the vicinity of the network control device (302) by receiving an indication from another network control device proximate the network control device (304). In another example, the dangerous condition may be a flood in the vicinity of the network control device (302). Other dangerous conditions of which the network control device may warn the early warning devices include: riots; gang activity; impending natural disasters such as storms, volcanos, tsunamis, earthquakes; and the like.

A mute instruction, on the other hand, may be transmitted from the network control device (302) responsive to the network control device receiving an instruction from the central hub (304) having determined that there is a malfunctioning early warning device within range of the network control device (302), or a flood condition or the like has passed.

FIG. 3 shows an early warning device (100.1) detecting a dangerous condition in the form of a fire (306) in a house or dwelling within the community. Responsive to detecting the fire (306), the early warning device (100.1) triggers an alarm and, after a delay period of 20 seconds to enable the occupants of the dwelling to mute the device if there is no community wide danger, transmits an alarm signal to surrounding early warning devices within range (100.2). The surrounding early warning devices within range (100.2 ) may, for example, be the early warning devices of neighbouring houses or dwellings. If the early warning device (100.1) was inadvertently triggered or a fire has quickly been extinguished, it can be silenced, and an alarm signal prevented from being transmitted, by activating a switch thereon.

The surrounding early warning devices (100.2) receive the alarm signal from the early warning device (100.1) having detected the dangerous condition, causing the alarms of the surrounding early warning devices (100.2) to trigger. The surrounding early warning devices (100.2) then increment a count value included in the alarm signal retransmit the alarm signal to those additional early warning devices now within their range (100.3).

The alarm signal continues to propagate through this mesh-network of early warning devices (100) within the community, with the count value being incremented each time an alarm signal is received by an early warning device. Where the count value is below a first value, in this exemplary scenario being 3, the early warning devices trigger an alarm thereby warning occupants of the respective house or hut in which the device is fitted of the imminent danger.

However, as the count value of alarm signals exceeds the first value, the alarms of the early warning devices receiving this signal (e.g. 100.5) are not triggered. These devices (100.5) retransmit the alarm signal to early warning devices within range and do not trigger their alarms. This ‘silent propagation’ of alarm signals continues as long as the count value included in the alarm signals is less than a second value, in this exemplary scenario being 10.

The use of a count value in the alarm signal prevents widespread propagation of alarm signals which could unnecessarily disrupt the entire community. Retransmitting alarm signals silently for (in this exemplary scenario) another seven hops enables the alarm signal to reach the network control device (302) which can in turn report the dangerous condition to the central hub (304). This enables the relevant authorities, for example the fire department and other emergency services, to be alerted to the dangerous condition and respond appropriately. Of course, if the fire (306) itself has spread, then other early warning devices will independently transmit their alarm signals and there will always be at least 3 hops of surrounding devices with their alarms sounding, enabling occupants of dwellings close to the fire to evacuate safely.

The central hub (304) can estimate, using the geo-location received from the network control device (302) as well as the count value, an approximate location of the fire. The location may be estimated as a radius from the geo-location of the network control device (302) based on the count value and the average distance between each early warning device (100).

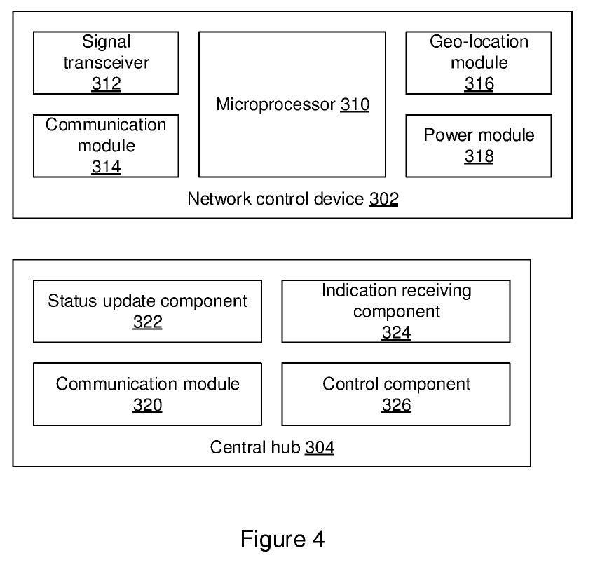

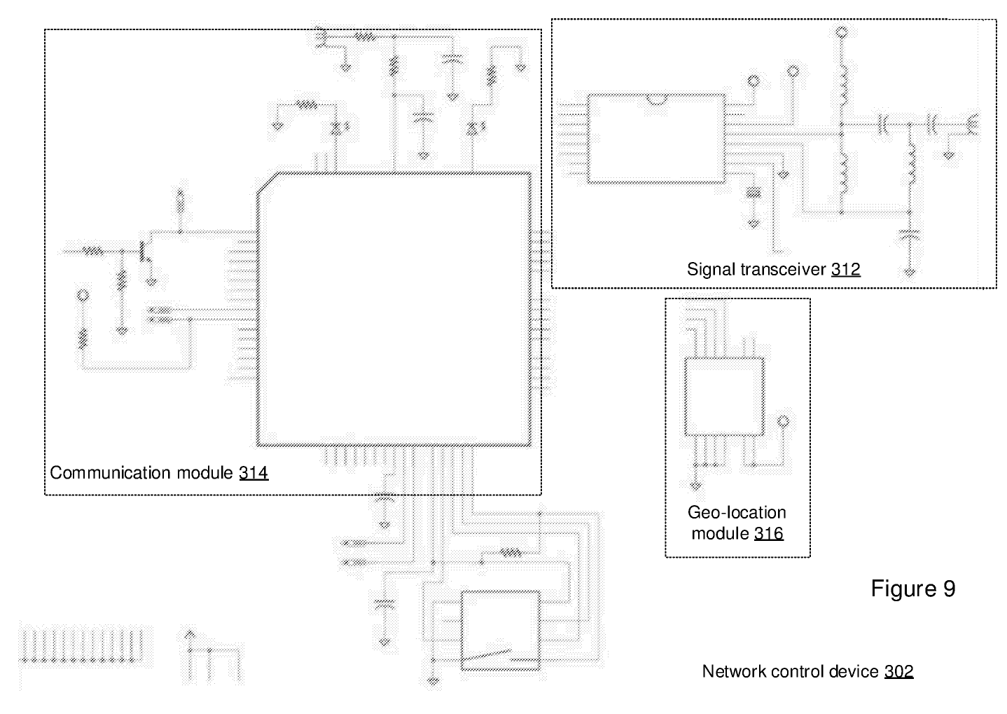

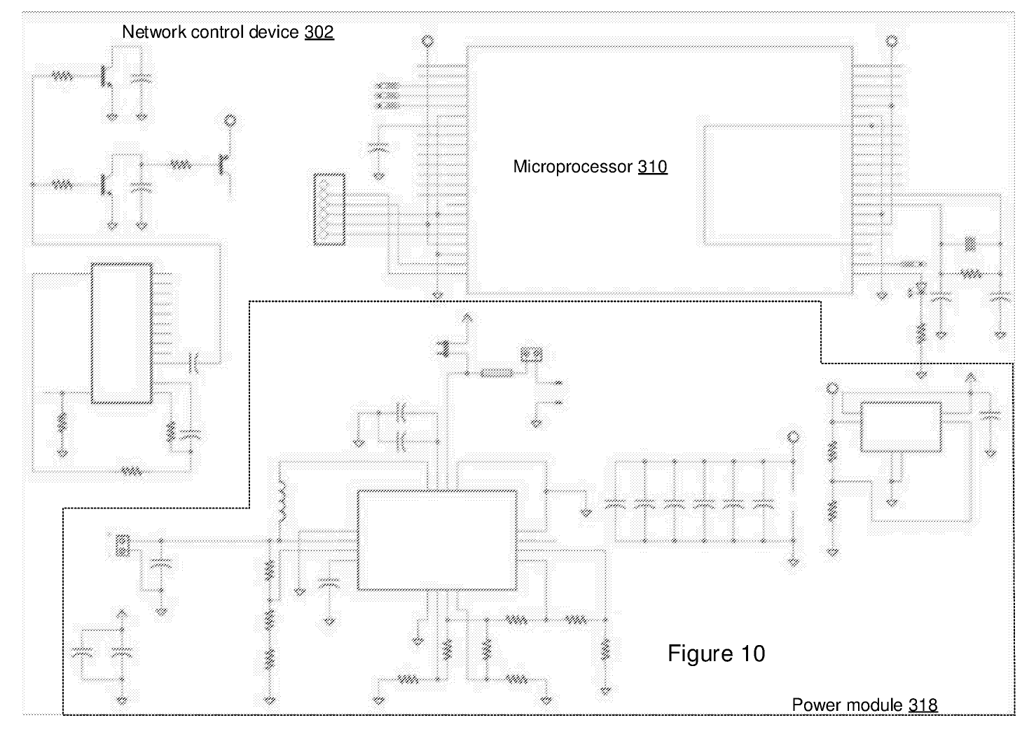

An exemplary network control device (302) and central hub (304) are illustrated in greater detail in FIG. 4 in schematic form and the circuitry is shown in FIGS. 9 and 10.

The network control device (302) includes a microprocessor (310) a signal transceiver (312), a communication module (314), a geo-location module (316) and a power module (318). The microprocessor (310) may be any appropriate microprocessor or suitable alternative and controls operations of the network control device (302). The microprocessor (310) is connected to the signal transceiver (312), communication module (314) and geo-location module (316) and is operable to periodically transmit status updates and indications of dangerous conditions to the central hub (304). The microprocessor implements a watchdog, or ‘computer operating properly’, timer to reset the network control device in the event of single event upsets, also called electronic glitches, and other malfunctions that might otherwise cause the electronic circuitry to malfunction. The microprocessor may use a large lithography complementary metal oxide (CMOS) timing circuit to implement the watchdog functionality, making it more impervious to single event upsets.

The signal transceiver (312) is operable to transmit and receive messages and data to and from surrounding early warning devices (100). The signal transceiver (312) is similar to that of the early warning device (100) and may include an antenna and a dedicated radio transceiver. The signal transceiver (312) may scan the 433 MHz frequency band for communications between early warning devices and is operable to receive alarm signals from surrounding early warning devices (100) and to transmit control messages to surrounding early warning devices.

The communication module (314) provides wireless communication functionality with a communication network such as a mobile phone network. The communication module (314) includes an antenna and a radio transceiver to enable it to communicate using global system for mobile communications (GSM), general packet radio services (GPRS) or other appropriate communication standards. The communication module (314) enables the network controller (302) to transmit and receive data and messages to and from the central hub (304). Thus, using the communication module (314), the network controller (302) is operable to instructions from and transmit indications to the central hub (302).

The geo-location module (316) is a global positioning system (GPS) system-on-a-chip or other appropriate geo-location receiver enabling the network control device (302) to determine its geographical location. In some embodiments, the network control device (302) may have its geographical location stored in a memory thereof obviating the need for a geo-location module.

The power module (318) includes a battery, a solar panel, a solar energy scavenging module and a voltage regulator and is operable to provide electrical power to the network control device (302).

The central hub (304) may be a computer or server computer such as a web server or the like. The central hub (304) includes a communication module (320) for transmitting and receiving messages and data to and from the network controller (302). The central hub (304) may further include a status update component (322) for receiving status updates from the network control device (302) and an indication receiving component (324) for receiving indications from the network control device (302) via the communication module (320). The central hub (304) also includes a control component (336) for transmitting control messages to the network controller (302) via the communication module (320).

The status update component (322), indication receiving component (324) and control component (336) may be implemented in software and, in some embodiments, as internet scripts. Messages sent between the central hub (304) and the network control device (302) may be in the form of hypertext transfer protocol (http) messages such as http get and http post messages. Alternatively, the messages may be email messages.

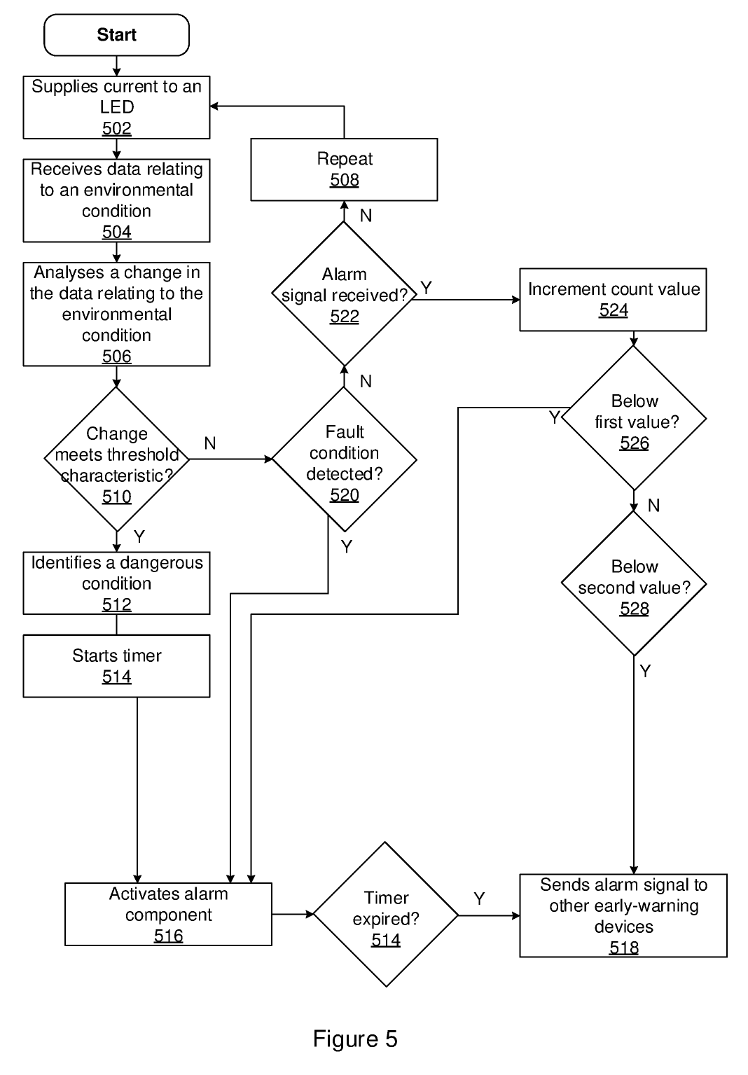

FIGS. 5 to 7 are flow diagrams which illustrate an exemplary method for detecting and reporting dangerous conditions in a community. The method is conducted at an early-warning device as described herein.

The described method is conducted after the device has been booted up and performed an initialization sequence. The initialization sequence may include setting up input/output lines and an internal oscillator, device testing of the LED and, if the LED is not open circuit, initializing variables, as well as configuring of the transmitter and wake up feature. Once the device has been initialized, it may begin to detect temperature.

Referring to FIG. 5, at a first stage (502), the device supplies a current to LED in order to raise the forward biased voltage over the LED causing the LED to flash and thereby to indicate a normal operating status to a user.

At a next stage (504), the device receives data relating to an environmental condition from the LED. The environmental condition is this example is temperature and the data relating to the environmental condition is a forward-biased voltage measured over the LED.

The device analyses a change in the data relating to the environmental condition over time at a next stage (506). Analysing the data relating to the environmental condition over time may include obtaining a temperature measurement from the data and analysing a change in the measured temperature samples using a buffer as previously described.

These stages (502, 504, 506) repeat (508) periodically to periodically produce samples of data relating to the environmental condition. If (510) the change in the data relating to the environmental condition meets a threshold characteristic, the device identifies a dangerous condition at a following stage (512). The threshold characteristic indicating a dangerous condition is that the measured temperature has increased by at least a certain amount for a certain number of successive samples. For example, the threshold characteristic may be that the rate of rise of the temperature data has increased by a predetermined amount from one sample to the next for a predetermined number of samples. Upon identifying a dangerous condition at a following stage (512), a count value is initialised.

If a dangerous condition is identified the device starts a timer at a next stage (514) and immediately, at a following stage (516), the device activates an alarm component. The alarm component may be configured to operate in different modes depending on the count value of the associated alarm signal. For example, where the count value is one, the alarm component may be activated while, where the count value is greater than one, the alarm component may be configured to be activated in a periodic fashion.

At some stage during the delay, the device may receive a reset command, responsive to which the device deactivates the alarm component, for example by silencing the buzzer or siren, and prevents an alarm signal from being transmitted.

Following expiry of the time delay, which may, for example be 15 s, 20 s, 25 s or the like, the device sends an alarm signal to other early-warning devices in range at a next stage (518). The alarm signal transmitted from the device includes the count value.

At an alternative stage (520), the device may detect a fault condition in the sensor (which may have resulted from the destruction of the exposed LED), responsive to which the device then immediately activates the alarm component at a next stage (516) and also, without delay, sends an alarm signal to other early warning devices in range at a following stage (518). This prevents a delay in circumstances where a fire is so ferocious that the device is likely to be destroyed before it sends an alarm signal. In some embodiments, responsive to detecting the fault condition, the device may initialise and increment the count value. The device is then configured to activate the alarm component and, for count values greater than one, to immediately transmit an alarm signal to other early warning devices in range.

At any stage during the device's operation, the device may receive one or more alarm signals from other early warning devices in range. If (522) the device receives an alarm signal, the device increments the count value included in the alarm signal at a next stage (524). If (526) the count value is below a first value, the device activates the alarm component at a next stage (516) and then retransmits the alarm signal, including the incremented count value, to other early-warning devices in range at a following stage (518). If the count value is greater than or equal to the first value and if (528) the count value is less than a second value, the device does not activate the alarm component, but does retransmit the alarm signal, including the incremented count value, to other early-warning devices in range at a following stage (518). This may be effected by setting a flag to prevent the alarm component from being activated. If the count value is greater than or equal to the second value, the alarm component is not activated and the alarm signal is not retransmitted.

At any stage during its operation, the device may receive control messages from a network control device. The control messages may be either an alarm instruction or a mute instruction and, if the control message is an alarm instruction, the device activates an alarm component and sends the alarm signal to other early-warning devices in range, or, if the message is a mute instruction, the device silences the alarm component. The device may respond to receiving an alarm instruction from a network control device in a manner similar to the way in which it responds to receiving an alarm signal from another early warning device.

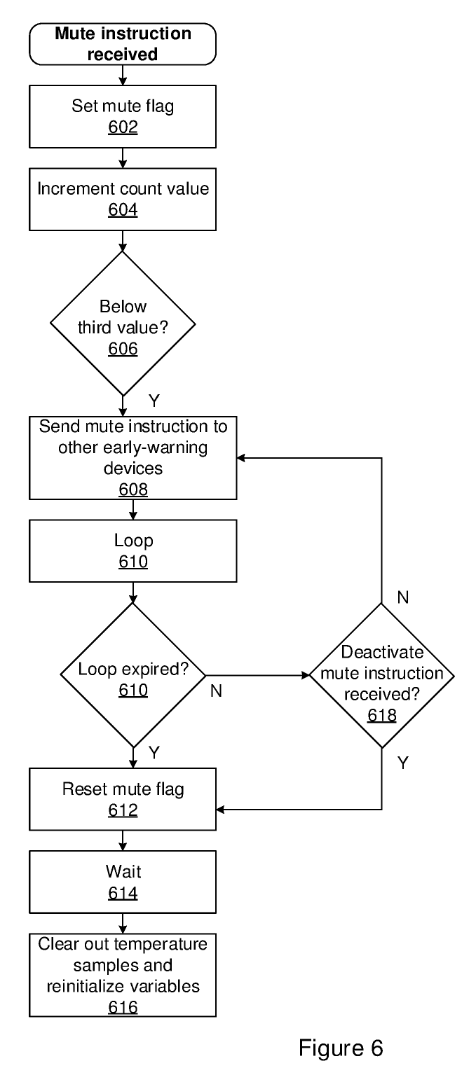

FIG. 6 illustrates steps taken if a mute instruction is received from a network control device. The mute instruction includes a count value and responsive to receiving the mute instruction, a mute flag is set at a first stage (602). At a following stage (604), the count value included in the mute instruction is incremented. At a next stage (606), the device determines whether the count value of the mute instruction is less than a third predetermined value. If (606) the count value is less than the third predetermined value, the mute instruction is transmitted to other early warning devices in range at a following stage (608). If (606) the count value is greater than or equal to the third value, the mute instruction is not retransmitted.

The stage (608) of transmitting the mute instruction may loop (610) for a predetermined period of time. Upon expiry of the predetermined period of time, the mute flag is reset at a following stage (612). The device then waits for a predetermined period of time at a following stage (614) to allow time for the network to stabilise and then clears out temperature samples and reinitializes variables at a next stage (616). At some stage (618) during the loop, the device may receive a control message including a deactivate mute instruction, responsive to which the device resets the mute flag at a following stage (612) and may also retransmit the deactivate mute instruction. The rules for retransmitting the deactivate mute instruction are similar to those described above for the mute instruction. The stage (516) of activating the alarm component is conditional on the mute flag not being set. Thus, where the mute flag is set, the alarm component will not be activated.

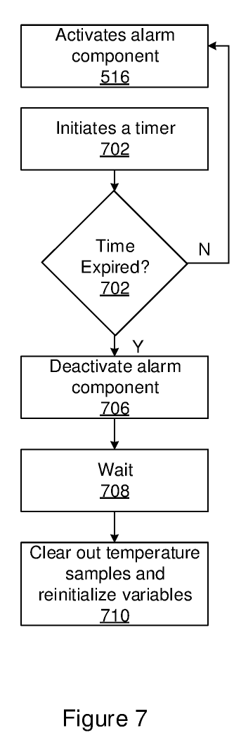

Embodiments also anticipate the stage (516) of activating the alarm component may include additional steps. FIG. 7 is a flow diagram which illustrates these additional steps conducted by the device responsive to the alarm component being activated. Responsive to the stage (516) of activating the alarm component, the device initiates a timer at a next stage (702). The device then determines whether the timer has been running for more than a predetermined period of time, for example being 3 minutes, at a following stage (704). If the alarm component has been active for more than the predetermined period of time, the device deactivates the alarm component at a next stage (706) and then waits a predefined period of time, for example also being 3 minutes, at a following stage (708) and then clears out temperature samples and reinitializes variables at a next stage (710).

FIG. 8 is a schematic circuit diagram of an exemplary early warning device (100) showing the sensor (102), microprocessor (104), signal transceiver (106), alarm component (108) switch (112) and power module (114).

FIGS. 9 and 10 are schematic circuit diagrams of an exemplary network control device (302) showing the microprocessor (310), signal transceiver (312), communication module (314), geo-location module (316) and power module (318).

The early warning device described herein senses the rate of rise of temperature in an environment to determine whether there is a dangerous fire present. In the case of a fire the device sounds and alarm to alert people in the home, and also alerts all neighbouring devices within about a 60 meter radius by means of radio frequency (RF) transmission.

The device needs to determine the temperature conditions inside of an average sized dwelling in the case of a fire in order to optimise the fire detecting algorithms and the placement of the device within a dwelling.

In light of a lack of data in this regard, a reasonable sized informal dwelling (3 m×4 m×2 m) was constructed and used for fire simulations under test conditions. The changes in temperature were measured by a series of nine thermocouples at different heights and distances from the source of the fire. The fires were contained in a one meter diameter steel dish which meant that all the results were conservative because none of the fires were allowed to spread.

By simulating a range of fires of different sizes and using different materials, a reasonable average rate of rise of temperature for dangerous fires was established. In the tests, all of the fires that were simulated reached a rate of rise of at least 25° C./min within less than one minute. This average was reached at a distance of 1.3 m from the source of the fire.

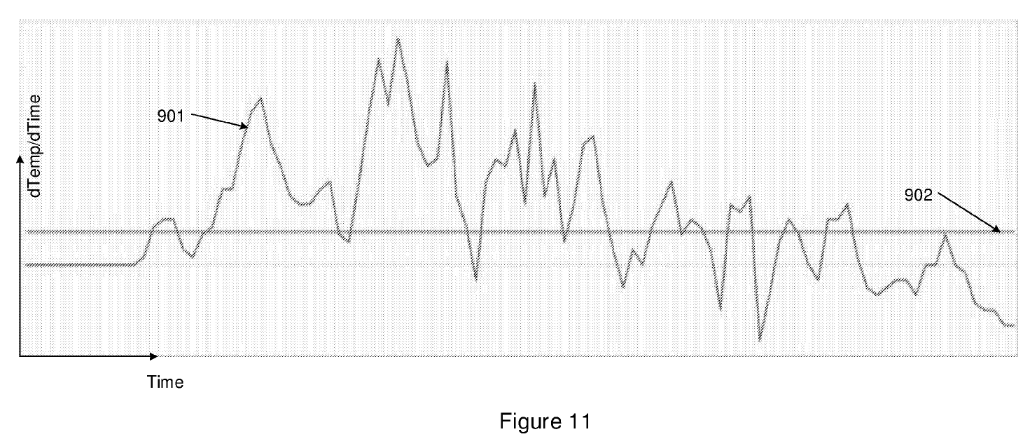

FIG. 11 shows the rate of rise of temperature for a dangerous fire at a distance of 1.3 m from the source of the fire (901). A line graph (902) showing the rate of rise of 25° C./min is also shown. It is clear from the graph that the fires exceeded this rate of rise within a minute. Each testing probe consisted of three thermocouples at heights of 600 mm, 900 mm and 1200 mm from the ground.

By comparing temperature readings of each of the probes it was established that the higher probe consistently read higher temperatures than the lower probes. This result makes it clear that the device should be placed as high as possible in the hut to increase its sensitivity. However, in order to make sure the device can be muted, it should be placed as high as possible within reach of the user.

The temperature probes were also placed at various distances from the source of the fire to test the effect of horizontal distance on temperature profiles. The temperature recorded directly above the fire was significantly greater than the other probes. However, at horizontal distances of greater than a metre, the difference in temperature is less significant. This is a consequence of having such a small volume testing environment (a reasonable sized informal dwelling). Due to the typically small volume of a dwelling in informal settlements, the distance from a fire is not critical in providing an early warning, provided that the device and the fire are in the same room. Furthermore, this result is conservative, because all natural fires would spread and would cause the device to trigger even sooner than predicted by the tests which used contained fires.

Tests were also conducted to determine how the orientation of the device affected its response time. Two devices were placed at an equal horizontal distance and height from a variety of fires. The first device was mounted on the roof with the sensor facing downward and the second device was mounted on a wall with the sensor facing outward. The tests showed that the device mounted on the wall performed significantly better (up to 10 seconds faster) then the device mounted on the ceiling.

The early warning device has a failsafe feature where, in the event of a fire which has grown to the extent that it causes the device itself to catch on fire, should the alarm not have already rung and/or if the transmission to local devices has not yet been sent, both of these functions will occur immediately. This was tested during the aforementioned fire tests, and the device successfully triggered its alarm and all the surrounding devices immediately in every test instance.

The device needs to be sensitive enough to warn against fires quickly but not too sensitive so as to trigger in the case of a false alarm (stoves, heater, candles etc.). By simulating many different types and sizes of fire it was established that a rate of 25° C./min rise of temperature represented a safe measuring level to identify dangerous fires. Heat profiles of many false alarm scenarios were measured, including heaters (gas and air heaters), small contained cooking fires, and gas stoves. A rate of rise directly above a gas stove or a gas heater are similar to that of a fire. However, at small distance away this is no longer the case. Of course, if the alarm of the device were to trigger immediately after a heater was turned on directly below it, the user would realise the mistake and mute the device using the switch.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), or a magnetic medium such as a hard-drive. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. An early warning device for detecting and reporting dangerous conditions in a community, comprising:
a sensor which detects an environmental condition at the device;
a microprocessor which receives data relating to the environmental condition from the sensor, analyses a change in the environmental condition over time, and identifies a dangerous condition if the change in the environmental condition meets a threshold characteristic;
a signal transceiver connected to the microprocessor which sends an alarm signal to other early-warning devices in range if a dangerous condition is identified, and which receives alarm signals from other early-warning devices in range; and
an alarm component connected to the microprocessor;
wherein the alarm component is activated by either the identification of a dangerous condition at the device, or by receiving one or more alarm signals from other early warning devices in range, so that a plurality of early-warning devices are triggered in the event of a dangerous condition being identified at one or more of them.

2. An early warning device as claimed in claim 1, wherein the dangerous condition is a fire, the sensor is a temperature sensor, and the environmental condition is temperature.

3. An early warning device as claimed in either one of claim 1 or 2, wherein the signal transceiver is short range radio frequency transceiver that transmits a signal over a range of 1-100 meters in an unlicensed frequency band.

4. An early warning device as claimed in any one of the preceding claims, wherein the temperature sensor is a light emitting diode (LED) and the data received from the LED is a forward-biased voltage over the LED.

5. An early warning device as claimed in claim 4, wherein the microprocessor periodically supplies a current to the LED in order to raise the forward biased voltage over the LED causing the LED to flash and thereby to indicate a normal operating status to a user.

6. An early warning device as claimed in claim 4 or claim 5, wherein the device includes a housing and the LED protrudes from the housing, and wherein apertures are provided in the housing adjacent to and substantially surrounding the LED to ensure that the LED is exposed to the ambient environment to ensure that a change in ambient temperature can be detected.

7. An early warning device as claimed in any one of the preceding claims, wherein temperature measured by the sensor is sampled on a periodic basis, and the threshold characteristic indicating a dangerous condition is that the measured temperature has increased by at least a certain amount for a certain number of successive samples.

8. An early warning device as claimed in any one of the preceding claims, wherein the microprocessor is further configured to detect a fault condition in the sensor and to then immediately activate the alarm component and the signal transceiver to send an alarm signal, to thereby prevent a delay which could otherwise result in the device being destroyed before it is capable of transmitting the alarm signal.

9. An early warning device as claimed in claim 8, wherein the fault condition is the monitored forward biased voltage exceeding a threshold value.

10. An early warning device as claimed in any one of the preceding claims, wherein the alarm component is a buzzer or siren, wherein the device includes a delay timer which initiates a time delay between the activating of the alarm component and the sending an alarm signal to other early-warning devices in range, and wherein the device includes a switch which is operable to reset the device, so that the device can be reset during the time delay so as to silence the buzzer or siren and prevent an alarm signal from being transmitted.

11. An early warning device as claimed in any one of the preceding claims, wherein the device is operable to retransmit an alarm signal it has received from another early warning device, and for the alarm signal transmitted by the device to include a count value which is received and incremented before being transmitted, so that each retransmitted alarm signal is associated with a count value which indicates the number of times it has been retransmitted.

12. An early warning device as claimed in claim 11, wherein the alarm component is only activated if the count value is below a first value; and wherein the alarm signal is only retransmitted if the count value is below a second value.

13. An early warning device as claimed in any one of the preceding claims, wherein the signal transceiver is operable to receive control messages from a network control device, the control messages being one of: an alarm instruction or a mute instruction, wherein, if the control message is an alarm instruction, the alarm component is activated and the alarm signal is sent to other early-warning devices in range, or, if the message is a mute instruction, the alarm component is silenced and the alarm signal is not transmitted.

14. An early warning device as claimed in claim 13, wherein the network control device is operable to transmit status updates including its geo-location position to a central hub and receive instructions from the central hub, the central hub being capable of activating early-warning devices in range of the network control device upon detection at the central hub of a dangerous condition in the vicinity of the network control device.

15. An early warning device as claimed in either one of claim 13 or 14, wherein the LED is a red green blue (RGB) LED and wherein if the alarm instruction received from the network controller device is a fire alert, outputting a first colour on the RGB LED, or if the alarm instruction received in a message from the network controller device is a flood alert, outputting a second colour on the RGB LED.

16. An early warning system for detecting and reporting dangerous conditions in a community, the system comprising a plurality of early warning devices as claimed in any one of the preceding claims.

17. An early warning system as claimed in claim 16, including a network control device and a central hub,
the network control device including:
a signal transceiver operable to receive alarm signals from early-warning devices within range; and,
a communication module which is operable to transmit, responsive to the signal transceiver receiving an alarm signal from an early-warning device, an indication of a dangerous condition to a central hub;
and the central hub including:
a communication module operable to receive indications of a dangerous condition from the network control device.

18. An early warning system as claimed in claim 17, wherein the communication module of the central hub is further operable to transmit instructions to the network control device, wherein the instructions include a mute instruction or an alarm instruction, wherein the communication module of the network control device is further operable to receive instructions from the central hub and wherein, responsive to receiving an instruction, the signal transceiver of the network control device is further operable to transmit control messages to early-warning devices within range, the control messages being one of an alarm instruction or a mute instruction.

19. An early warning system as claimed in claim 18, wherein the signal transceiver of each one of the plurality of early-warning devices is operable to receive a control message and, if the received control message is an alarm instruction, the alarm component of the device is activated and the alarm signal is sent to other early-warning devices in range, or, if the message is a mute instruction, the alarm component of the device is silenced and the alarm signal is not transmitted.

20. An early warning system as claimed in any one of claims 17 to 19, wherein the network control device includes a geo-location module for determining a geo-location position of the network control device, and wherein the communication module of the network control device periodically transmits status updates including the geo-location position to the central hub.

21. A method for detecting and reporting dangerous conditions in a community, the method being conducted at an early-warning device and comprising:
receiving data relating to an environmental condition from a sensor;
analysing a change in the environmental condition over time;
if the change in the environmental condition meets a threshold characteristic, identifying a dangerous condition;
if a dangerous condition is identified, or responsive to receiving one or more alarm signals from other early warning devices in range, activating an alarm component; and,
responsive to activating an alarm component, sending an alarm signal to other early-warning devices in range.

22. A method as claimed in claim 21, wherein the sensor is an LED and receiving data includes receiving a forward-biased voltage read over the LED.

23. A method as claimed in claim 22, including periodically supplying a current to the LED in order to raise the forward biased voltage over the LED causing the LED to flash and thereby to indicate a normal operating status to a user.

24. A method as claimed in any one of claims 21 to 23, wherein analysing a change in the environmental condition over time includes analysing temperature samples, and wherein the threshold characteristic indicating a dangerous condition is that the temperature has increased by at least a certain amount for a certain number of successive samples.

25. A method as claimed in any one of claims 21 to 24, including detecting a fault condition in the sensor and then immediately activating an alarm component and sending an alarm signal to other early warning devices in range, thereby preventing a delay which could otherwise result in the device being destroyed before it is capable of transmitting the alarm signal.

26. A method as claimed in any one of claims 21 to 25, including, if a dangerous condition is identified, initiating a time delay between the step of activating the alarm component and the step of sending an alarm signal to other early-warning devices in range.

27. A method as claimed in any one of claims 21 to 26, including retransmitting an alarm signal received from another early warning device.

28. A method as claimed in any one of claims 21 to 27, wherein the alarm signal sent by the device includes a count value, the method including incrementing the count value before retransmitting an alarm signal, so that each retransmitted alarm signal is associated with a count value which indicates the number of times it has been retransmitted.

29. A method as claimed in claim 28, wherein the alarm component is only activated if the count value is below a first value; and wherein the alarm signal is only retransmitted if the count value is below a second value.

30. A method as claimed in any one of claims 21 to 29, including receiving control messages from a network control device, the control messages being one of: an alarm instruction or a mute instruction, wherein, if the control message is an alarm instruction, the method including activating an alarm component and sending the alarm signal to other early-warning devices in range, or, if the message is a mute instruction, the method including silencing the alarm component.
